(19) United States
(12) Patent Application Publication
(10) Pub. No.: US 2017/0052022 A1
(43) Pub. Date: Feb. 23, 2017

(54) HIGHLY REFLECTIVE SURFACE PROFILE MEASUREMENT SYSTEM WITH LIQUID ATOMIZATION AND THE METHOD THEREOF

(71) Applicant: INDUSTRIAL TECHNOLOGY RESEARCH INSTITUTE, HSINCHU (TW)

(72) Inventor: Kuo-Feng HUNG, Taoyuan (TW)

(21) Appl. No.: 14/858,629

(22) Filed: Sep. 18, 2015

(30) Foreign Application Priority Data
Aug. 17, 2015 (TW) 104126751

(51) Int. Cl. G01B 11/24; B05B 9/03

(52) U.S. Cl. CPC G01B 11/24; B05B 9/03

(57) ABSTRACT

A highly reflective surface profile measurement system with liquid atomization and a method thereof are both provided. The method includes the following steps: spraying a liquid to form a droplet layer on the surface to reduce temporarily the roughness; scanning the surface by emitting an incident light and receiving a reflected/refracted light to obtain an electric signal; and processing the electric signal to generate an output which carries with the profile or the defect information of the surface.

### CROSS-REFERENCE TO RELATED APPLICATIONS

This non-provisional application claims priority under 35 U.S.C. §119(a) on Patent Application No(s). 104126751 filed in Taiwan, R.O.C. on Aug. 17, 2015, the entire contents of which are hereby incorporated by reference.

### BACKGROUND OF THE DISCLOSURE

1. Field of the Disclosure

The disclosure relates to a surface profile measurement system and a method thereof, and particularly relates to a measurement system and a method for the surface profile of an article of which the surface has high reflection to light.

2. Description of Related Art

In view of general optical measurement technology, even a high precision equipment still cannot be allowed to receive much intensive light going into the interior of the equipment without filter. Unfortunately most modern consumption products normally have shiny or glary surfaces, i.e. these surfaces have been highly polished or extremely machined as to obtain a brighter looking, but as a result, that could also encounter a problem to measure the surface profile or to inspect defect precisely with optical measurement equipment. As to resolve such problem, some conventional processes may coat a chemical liquid or powder at first on the surface to be inspected to form an agent layer, but this layer needs to be removed away with additional process or facility at final and may possibly cause damage to the surface.

### SUMMARY OF THE DISCLOSURE

An embodiment of the disclosure provides a surface profile measurement system for an article of which the surface has high reflection to light, more particularly with a sprayer to form liquid droplets on the surface to reduce the roughness temporarily. The system briefly comprises a platform; a light source to emit an incident light; a photoelectric sensor to receive a reflected/refracted light to convert into an electric signal; a sprayer to spray liquid drops; and a processor with a controller to activate the all above component to process the electric signal to generate an output.

According to another embodiment, a surface profile measurement method with a liquid atomizing step for an article's surface is also provided. The method briefly comprises: spraying a liquid to form droplets on the surface; scanning the surface to obtain an electric signal; and processing the electric signal to generate an output.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A-1B are diagrams to illustrate separately about specular reflection and diffuse reflection.

FIG. 2 is a diagram to illustrate diffuse reflection caused by an incident light emitting toward a surface on which a tiny water droplet is attached.

FIG. 3 is a diagram to illustrate a surface profile measurement system according to the disclosure.

FIG. 4 is a flowchart to illustrate a surface profile measurement method according to the disclosure.

### DESCRIPTION OF EMBODIMENTS

In order to make a better realization of the disclosure, the following description in detail is taken as examples, but should not limit to explain various embodiments complied with the spirit of the disclosure. Those who skilled in the art can easily replace any component or process with other from the disclosure, but such the replacement should obviously be covered under the scope of the disclosure.

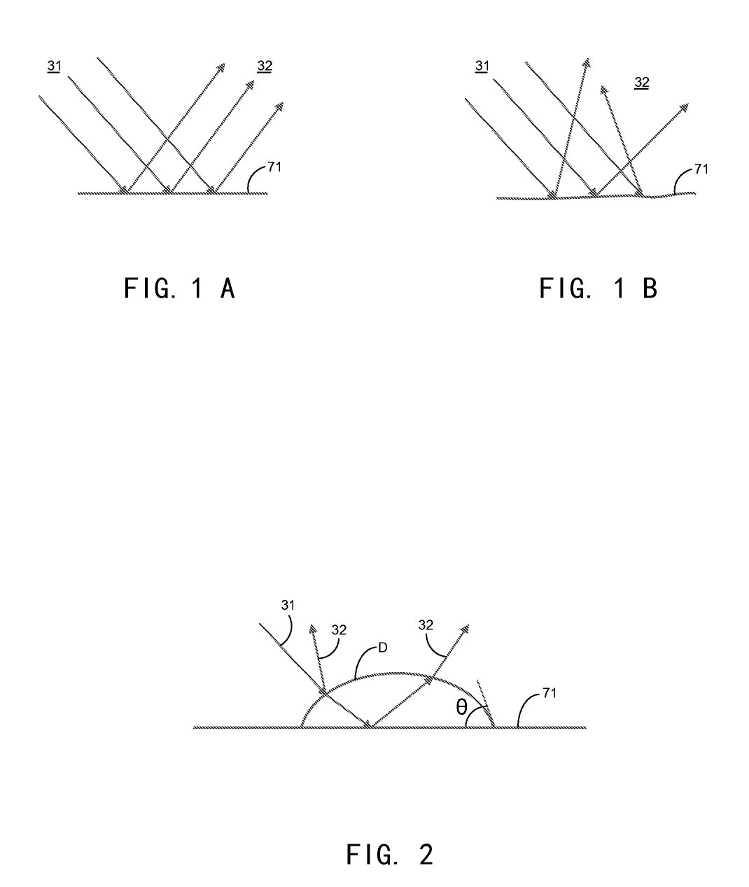

FIG. 1A is a diagram to illustrate how a specular reflection happened on a smooth surface. When a parallel incident light 31 emits toward the surface 71, straight or curved, of an article at a single incident angle, a reflected light 32 at the same angle should occurs to the opposite side of the normal line to the surface. The reflected light 32 normally has strong intensity specially if the surface has higher smoothness or lower roughness. If the reflected light 32 with stronger intensity goes into an optical measurement equipment without any filter will cause damages to the equipment. However, by the other hand, if the surface has higher roughness or lower smoothness, as shown in FIG. 1B, a diffuse reflection at different reflection angles with weaker intensity can be captured into equipment for obtaining a better measurement result on surface profile or defect inspection.

FIG. 2 is a diagram to illustrate how a diffuse reflection caused by a water droplet on a surface to reduce temporarily the intensity of the reflected/refracted light according to an embodiment of the disclosure. The surface 71 of a consumption article, e.g. faucet related product, metal of plastic, has generally been fully polished or electroplated to have high smoothness, but as described above, it also gets a problem for non-contact optical measurement equipment. One embodiment of the disclosure introduces a system and a method to temporarily reduce the smoothness of the surface 71 on which a thin layer of water droplet D is formed to build up a diffuse reflection as to capture the reflected/refracted lights 32 to optical equipment for measurement. The incident light 31 emits toward the droplet D, water or other, can be refracted inside and/or reflected out the droplet D at different angle, so that the lights 32 with weaker intensity can be processed later to obtain the true profile information of the surface or the location of real defect. Although the above embodiment describes a layer of water droplet, other liquid can be also considerable to apply with.

Different liquid droplet on a surface will have different contact angle θ, it depends on surface tension of the liquid and roughness of the surface, and furthermore different contact angle will also cause different reflected angle of light. Please refer to FIG. 2, a suitable selection of contact angle may further refer to the material of article, surface's condition and measurement process. The disclosure uses water as a droplet layer mainly because no additional process or facility is needed to remove away later, water droplets will be vaporized back to the air at ambient temperature after measurement. Other liquid such as methanol can also be considered only if the contact angle is acceptable, smaller contact angle will cause wetting on the surface which the smoothness cannot be effectively lowered, but bigger contact angle will also cause rolling of droplet which cannot firmly attach on the surface, especially on a free formed surface.

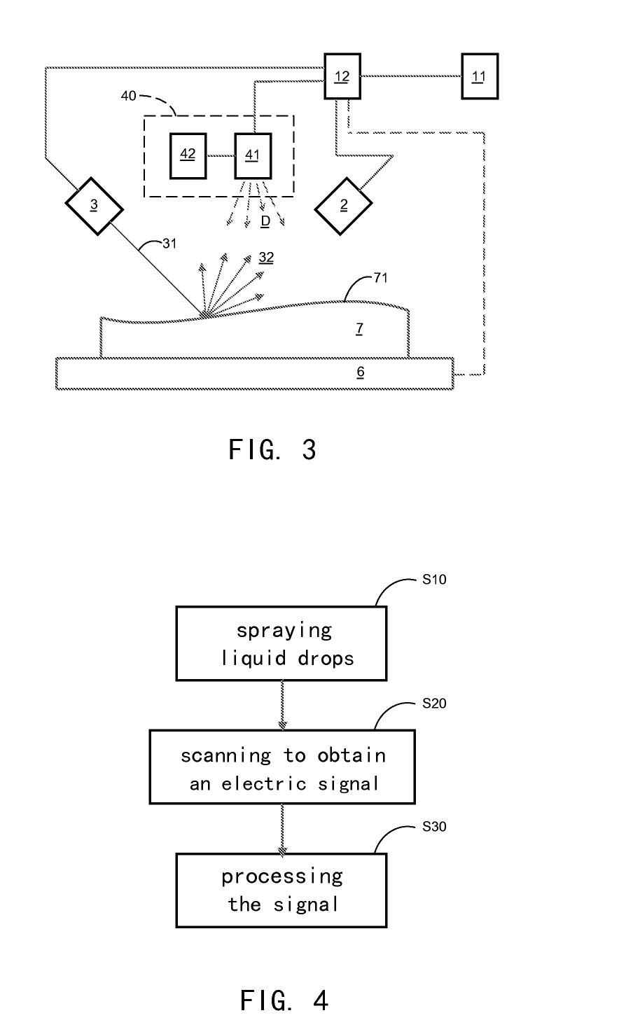

FIG. 3 is a diagram to illustrate a surface profile measurement system with water atomization according to another embodiment of the disclosure. As to carefully describe how to form water/liquid droplet on to measure the surface of an article in the embodiment, the system for example is constituted namely with a platform 6 or a conveyor (not shown in figures) which is capable to load a workpiece 7 with surface 71 to be measured, a photoelectric sensor 2, a light source 3, a sprayer 40 consisted further of a plurality of nozzle 41 and a liquid container 42, the nozzles 41 can be mounted on any suitable positions above the platform 6, and a processor 11 connected to the photoelectric sensor 2, the light source 3 and the sprayer 40 by electricity through a controller 12 as to proceed activity driving, data collecting, signal processing and so on. The platform 6, if necessary, is connected to the controller 12 to be controlled to move straightly or rotate around, however if the platform 6 is stationary, the photoelectric sensor 2 and the light source 3 can be moved relatively to each other as to proceed scanning and capturing. The photoelectric sensor 2 and the light source 3 may also be combined together physically as a single component. The description although has described the all elements and their functions as above, any used wordings or number should not be taken as limitations to the explanation of the disclosure.

As to complete the description of the embodiment, please refer to FIG. 3 again. The processor 11 orders the controller 12 to activate the nozzles 41 of the sprayer 40 at any positions to spray water/liquid drops D form the container 42 toward the surface 71 after the workpiece 7 has been loaded already on the platform 6. The diameter of the water/liquid drop D may be from 0.1 to 2 μm which varies depends on actual situation, but to keep a uniformed and steady droplet layer on surface 71 in a whole measurement is much important. Once the droplet D on the surface 71 is formed, the nozzles 41 stop spraying and the light source 3 being controlled to emit incident light 31, e.g. blue light or red light, toward the surface 71 and to obtain the refracted/reflected light 32 through the droplet D before the photoelectric sensor 2. The photoelectric sensor 2 captures the light 32 to convert into electric signals to the processor 11 for further processing, such as to generate 3D spatial information of surface, to inspect corrosion or defect on surface and so on. The sprayer 40, the light source 3 and the photoelectric sensor 2 can also work continuously and cooperatively at different positions with the platform 6 if the platform 6 has been modified to be a conveyor.

Refer to the description of the embodiment above, FIG. 4 is a flowchart to illustrate how the measurement system is cooperated to proceed a measurement method. In step S10, the nozzles 41 of the sprayer 40 are activated by the processor 11 through the controller 12 to spray lots of tiny water/liquid drops toward the surface 71 as to form a thin droplet layer on the surface 71. The light source 3 then emits the incident light 31 and the photoelectric sensor 2 starts to scan the surface 71 in step S20 after step S10 is done. The reflected/refracted lights 32 acquired by the photoelectric sensor 2 will further be converted from pixel images to electric signals also inside the photoelectric sensor 2. The processor 11, in step S30, once received the electric signals carried the profile or defect information of the surface 71, will continually process to generate a measurement output of 3D spatial information of the surface 71 or defect location on the surface 71 at final stage.

In summary, the embodiments of the disclosure reveal a concept of application with water/liquid atomization to cooperate with optical measurement equipment to obtain the true profile information of a shiny surface. More particularly, the water/liquid droplets, even methanol, can vaporize back to the air without any extra process of facility, and no any other agent like hydrophobe, hydrophile or fluorescent is needed to be coated with on the surface at first, consequently no corresponding process or facility should be used to remove that agent either at final. An experiment for measuring the surface profile of an article has been proofed that the number of point cloud of a surface increases more than 80% by use of the embodiments of the disclosure.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A surface profile measurement system with liquid atomization, comprising:
a platform;
a light source configured to emit an incident light;
a photoelectric sensor configured to receive a reflected/refracted light to convert into an electric signal;
a sprayer configured to spray liquid drops,
a controller connected by electricity to activate the light source, the photoelectric sensor and the sprayer; and
a processor connected by electricity to the controller to process the electric signal.

2. The measurement system as claimed in claim 1, wherein the controller further connects the platform by electricity to drive to move or to rotate.

3. The measurement system claimed in claim 1, wherein the sprayer further comprises at least one nozzle.

4. The measurement system claimed as claim 1, wherein the sprayer further comprises a liquid container.

5. The measurement system claimed in claim 1, wherein the liquid drop is water drop.

6. A surface profile measurement method with liquid atomization for measuring an article's surface, comprising the steps of:
spraying a liquid to form droplets on the surface;
scanning the surface to obtain an electric signal; and
processing the electric signal to generate an output.

7. The measurement method as claimed in claim 6, wherein the scanning step further comprises emitting an incident light to the surface and receiving reflected/refracted lights.

8. The measurement method as claimed in claim 6, wherein the liquid is water.
